(19) United States
(12) Patent Application Publication
(10) Pub. No.: US 2016/0263763 A1
(43) Pub. Date: Sep. 15, 2016

(54) VISION SYSTEM

(71) Applicant: MIKKELSEN CONVERTING TECHNOLOGIES, INC., Milwaukee, WI (US)

(72) Inventors: Steen Mikkelsen, Milwaukee, WI (US); Darren R. Bolgioni, Cary, IL (US); Nikolai Mikkelsen, Milwaukee, WI (US)

(73) Assignee: Mikkelsen Converting Technologies, Inc., Milwaukee, WI (US)

(21) Appl. No.: 15/030,720

(22) PCT Filed: Oct. 16, 2014
(86) PCT No.: PCT/US2014/060916

§ 371 Date: Apr. 20, 2016

Related U.S. Application Data
(60) Provisional application No. 61/894,349, filed on Oct. 22, 2013.

(51) Int. Cl. B26D 5/00; G06T 7/00; B26F 1/38

(52) U.S. Cl. CPC B26D 5/007; B26F 1/3813; G06T 7/003; G06T 7/0044; G06T 2207/10004; G06T 2207/30108

(57) ABSTRACT

A process for cutting an image includes providing a sheet based graphic and providing a master graphic. A plurality of non-predetermined portions of the sheet based graphic are captured with a vision system. The plurality of non-predetermined portions of the sheet based graphic are registered with the corresponding portions of the master graphic. An offset of each of the plurality of non-predetermined portions of the sheet based graphic is identified with the corresponding portions of the master graphic.

### CROSS-REFERENCE TO RELATED PATENT APPLICATIONS

This application claims the benefit of U.S. Provisional Application No. 61/894,349, filed Oct. 22, 2013, entitled “VISION SYSTEM” which is incorporated herein by reference in its entirety.

### BACKGROUND OF THE INVENTION

The present application relates generally to the field of cutting graphic cutting equipment and more particularly to vision system for positioning a cutting pattern for a graphic sheet.

### SUMMARY

A cutting system includes a cutting table and a vision system for identifying the location of a graphic sheet on the cutting table.

In another embodiment a cutting system includes a vision system for adjusting the cutting pattern of a graphic sheet on the cutting table.

In one embodiment a process for cutting an image includes providing a sheet based graphic and providing a master graphic. A plurality of non-predetermined portions of the sheet based graphic are captured with a vision system. The plurality of non-predetermined portions of the sheet based graphic are registered with the corresponding portions of the master graphic. An offset of each of the plurality of non-predetermined portions of the sheet based graphic is identified with the corresponding portions of the master graphic.

In one embodiment an apparatus includes a vision system including a camera comprising a processor that includes instructions to capture a plurality of non-predetermined portions of a sheet based graphic positioned on a cutting surface as the camera is moved along a predetermined path over the cutting surface. The processor further includes instructions to register the plurality of non-predetermined portions of the sheet based graphic with corresponding portions of a master graphic stored in a memory. The processor also includes instructions to identify an offset of each of the plurality of non-predetermined portions of the sheet based graphic with the corresponding portions of the master graphic.

### BRIEF DESCRIPTION OF THE DRAWINGS

This application will become more fully understood from the following detailed description, taken in conjunction with the accompanying figures, wherein like reference numerals refer to like elements in which:

FIG. 1 is a top isometric view of a cutting system with a vision system.

FIG. 2 is a top isometric view of the cutting system of FIG. 1 with graphic sheet on the cutting table.

FIG. 3 is a top isometric view of the camera focused on a section of the graphic image.

FIG. 4 is a partial isometric view of a cutting tool cutting along a cut path on the graphic image.

FIG. 5 is the cutting system of FIG. 1 showing one vision path.

FIG. 6 is the cutting system of FIG. 1 showing another vision path.

FIG. 7 is the cutting system of FIG. 1 showing another vision path.

FIG. 8 is the graphic image showing the sections processed by the vision system.

FIG. 9 is a graphic image showing the comparison of the section identified in FIG. 8 with the regions on a graphic image stored in memory.

FIG. 10 is a close-up of one section of the one section processed by the vision system and compared with a corresponding region stored in memory and a vector showing the offset.

FIG. 11 is a graphic image showing examples of unique marks.

### DETAILED DESCRIPTION OF PREFERRED EMBODIMENTS

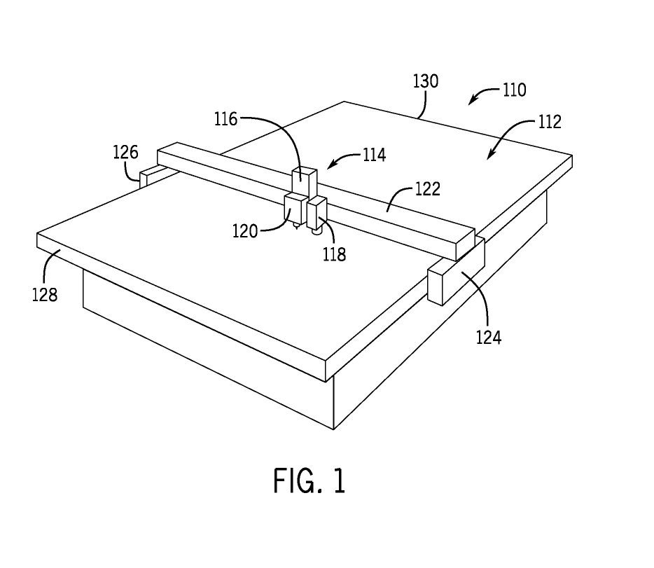

Referring to FIG. 1 a cutting system 110 includes a cutting table 112 and a cutting and vision mechanism 114. Cutting table 112 includes a first cutting surface and a conveyor system that is well known in the art. Cutting and vision system 114 are moved about cutting table 112 on a pair of side rails 124, 126 and a horizontal rail 122. Cutting and vision system 114 include a cutting head 116 supporting a cutting tool 120 such as a blade, a router, or other similar cutting tools known in the art. Vision system 118 may include a sensor such as an optical detector including but not limited to a CCD (Charge Coupling Device) camera known in the art to assist in locating a sheet 132 to be cut. At least one motor moves the cutting and visions system about table 112 horizontally between vertical sides 126 and 124 along horizontal bar 122 and vertically about table 112 in a direction along a perpendicular vector between front portion 128 and rear portion 130.

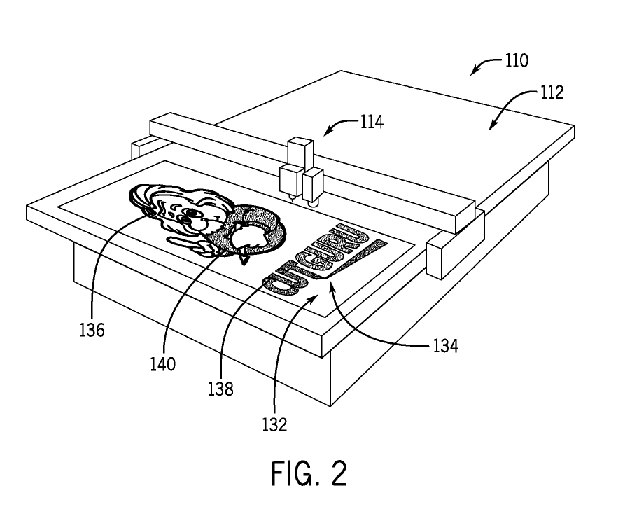

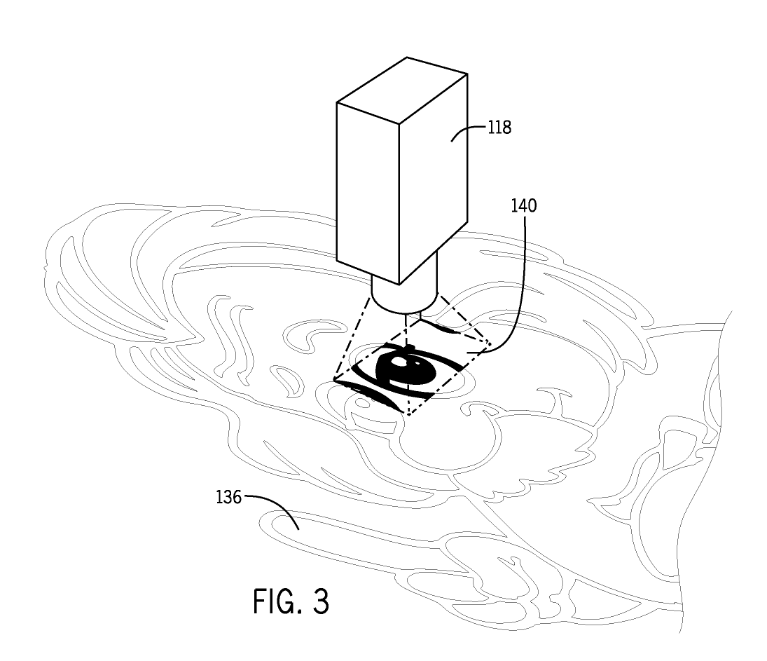

Referring to FIG. 2 a sheet 132 has a top surface 134 with a graphic image having various portions 136, 138 and 140. Referring to FIG. 3 vision system 118 including a sensor, such as a camera, images a portion 140 of the graphic image and stores the image in memory and/or processes the image in a processor. Cutting head 116 moves cutting tool about a cut pattern 142 to cut the graphic image from the sheet 132.

For purposes of this application, the term “processing unit” or “processor” shall mean a presently developed or future developed processing unit that executes sequences of instructions contained in a memory. Execution of the sequences of instructions causes the one or more processing units to perform steps such as generating control signals. The instructions may be loaded in a random access memory (RAM) for execution by the one or more processing units from a read only memory (ROM), a mass storage device, or some other persistent storage. In other embodiments, hardwired circuitry may be used in place of or in combination with software instructions to implement the functions described. For example, the functionality of ultrasound probe 10 may be implemented entirely or in part by one or more application-specific integrated circuits (ASICs). Unless otherwise specifically noted, the ultrasound console is not limited to any specific combination of hardware circuitry and software, nor to any particular source for the instructions executed by the one or more processing units.

For purposes of this application memory includes a non-transient computer-readable medium or other persistent storage device, volatile memory such as DRAM, or some combination of these; for example a hard disk combined with RAM. Memory contains instructions for directing the carrying out of functions and analysis by one or more processors. In some implementations, memory further stores data for use by the one or more processors. Memory stores various software or code modules that direct the processor to carry out various interrelated actions.

To ensure that the cutting tool 116 accurately cuts along the cutting path 142 that matches the desired outline of the graphic image to be cut, it is first required to identify the orientation of the graphic image on the sheet on the table. In certain systems a printed feature on the sheet such as a bulls eye or other type of locating features are printed on the sheet typically outside of the image to be cut to allow the system to locate the graphic image on the table. A processor than adjusts the orientation of the cut pattern to be used to match the orientation of the image to be cut. Referring to FIG. 3, in one embodiment, portions of the image itself are used to identify the orientation of the graphic image.

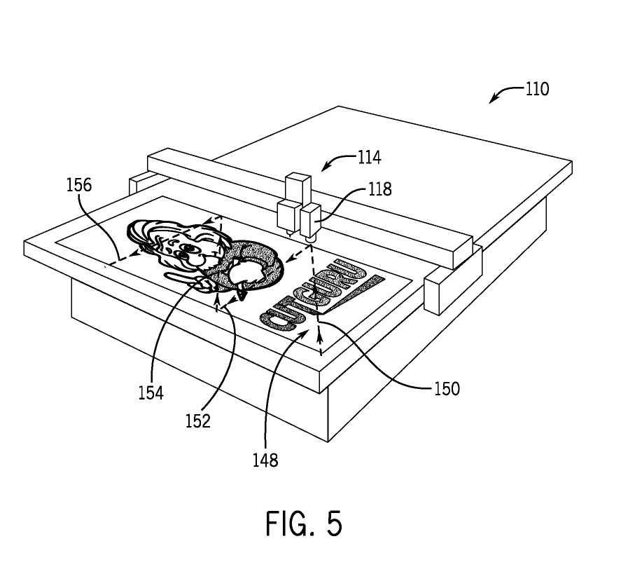

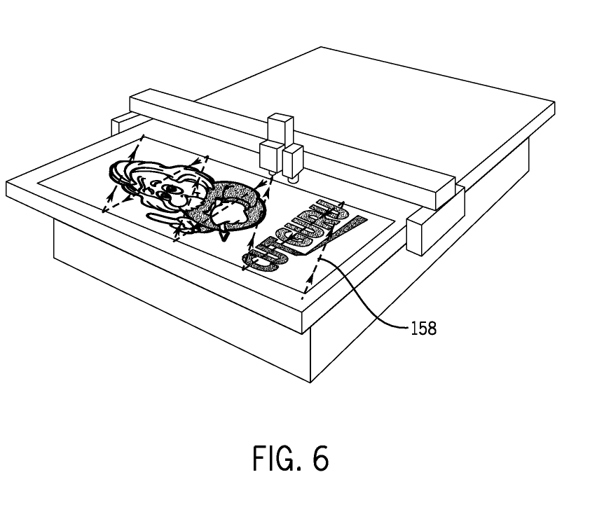

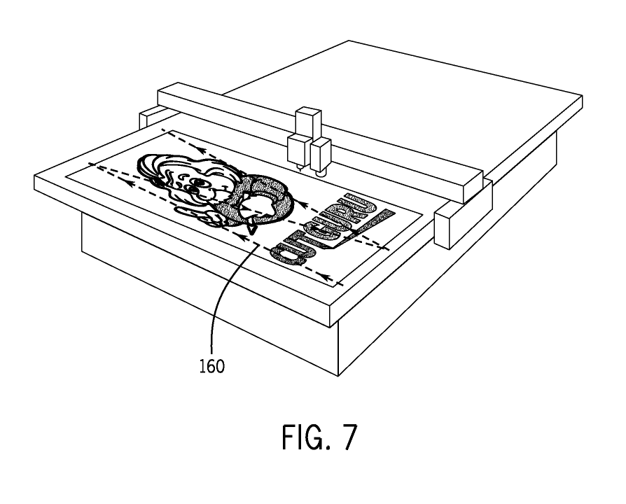

Referring to FIG. 5 vision system is moved over the sheet 132 in a predetermined path 148 having legs 150, 152, 154 and 156. As vision system is moved over the sheet 132 sections of the graphic image along the predetermined path on the sheet are captured by the camera on the vision system and stored in memory and or processed with a processor. Referring to FIG. 6 another predetermined path 158 may be used that includes additional legs. In the example illustrated in FIG. 6 predetermined path 158 includes seven legs, while the predetermined path 148 illustrated in FIG. 5 has 4 legs. Similarly, referring to FIG. 7 another predetermined path 160 has three legs in a different orientation than the legs illustrated in FIG. 5 and FIG. 6.

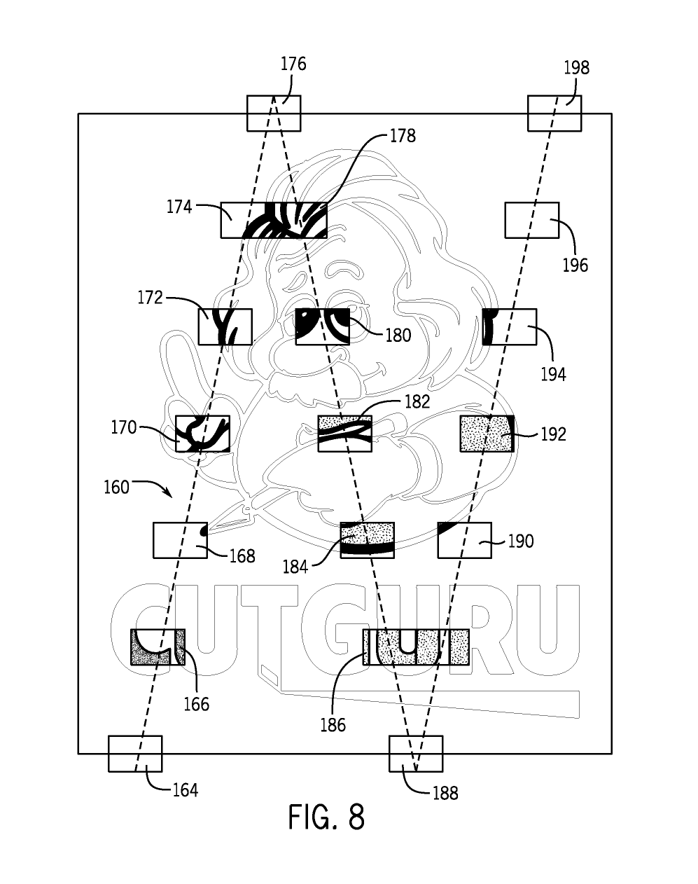

Referring to FIG. 8 the sections 164-198 of the graphic image on sheet 132 are shown along predetermined path 160. The sections 164-198 are captured by vision system as vision system is moved continuously along the predetermined path 160. However it is also contemplated that the vision system could pause at predetermined intervals along the predetermined path 160.

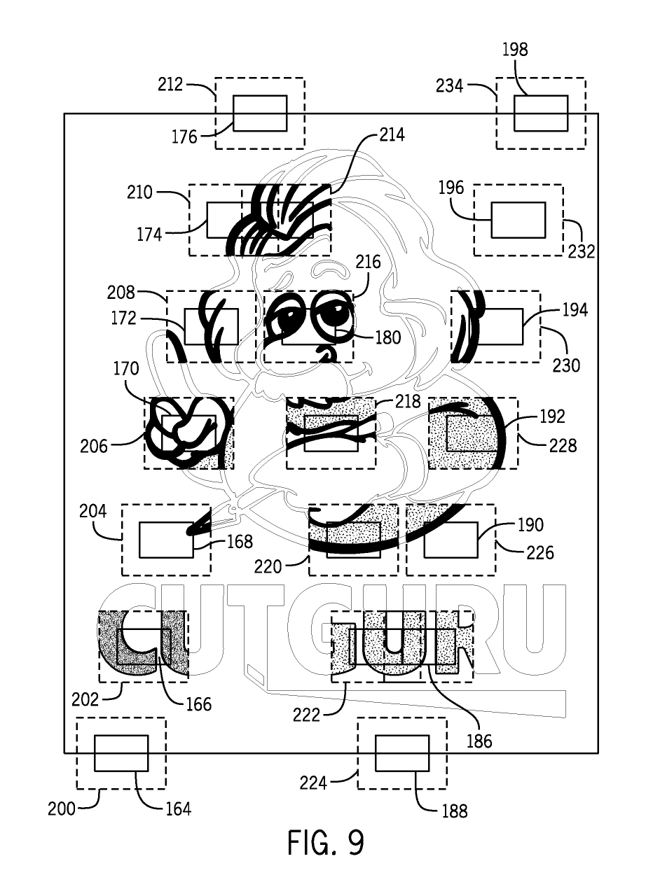

Referring to FIG. 9 the sections 164-198 are superimposed onto an intended graphic image that has been stored in memory of a processor. An algorithm in memory compares the sections 164-198 with regions 200-234 as illustrated in FIG. 9. The algorithm then calculates for each section 164-198 and corresponding region 200-234 the offset of the actual graphic image captured by the vision system with the intended graphic image stored within memory of the processor.

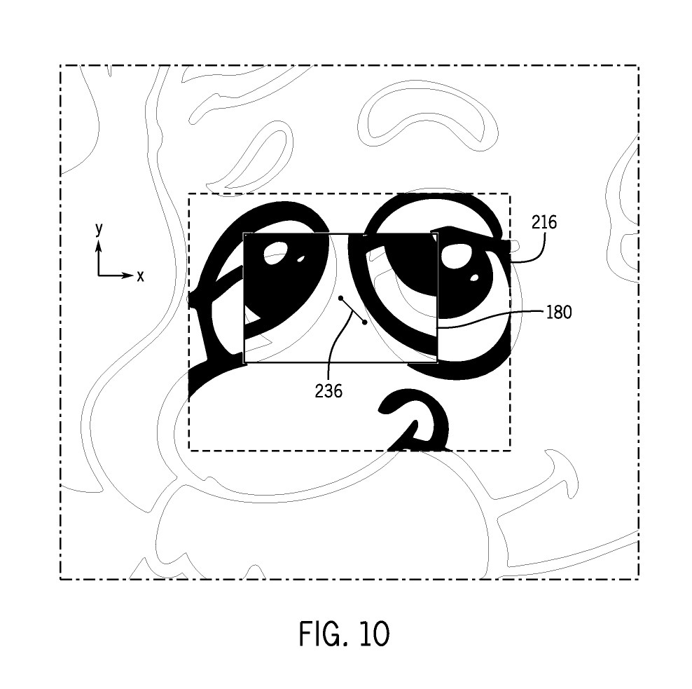

Referring to FIG. 10 the captured section 180 of the actual graphical image is compared to region 216 of the intended graphic image in memory. The algorithm then calculates the vector 236 showing the magnitude and direction of the offset of the actual section 180 to the intended graphic image region 216 stored in memory. A vector is provided for each section and region identified. Although the vector 236 in FIG. 10 does not include an arrow head one may be provided to illustrate the direction along the vector that the offset is calculated. It is contemplated that there may be as few as two sections and regions compared. In another embodiment the number of sections may be greater than 2. In the embodiment illustrated in FIGS. 8 and 9 nineteen sections may be compared. Referring to FIG. 8 sections 174 and 178 may overlap regions 210 and 214. In one embodiment a few sections of the actual graphic image may be captured and compared to the intended graphic image in memory to determine the orientation of sheet 132 on the table 112. The additional sections of the actual graphic image may then be captured to determine areas of linear distortion along the predetermined path. The vector length and direction of the linear distortion may be sued to revise the cutting pattern when the cutting tool actually cuts the actual graphic image on sheet 132. This is the case even though the cutting pattern is not along the predetermined path of the vision system. The relative locations of the cutting path relative to the cutting pattern may be calculated by an algorithm to best determine the actual cutting pattern rather than using an intended cutting pattern that would be appropriate for the intended graphic image. In another embodiment, all of the sections are used to both orientate sheet 132 as well as to determine the linear distortion along the path. It is also contemplated that the predetermined path would capture sections of the graphic image proximate the intended cutting pattern.

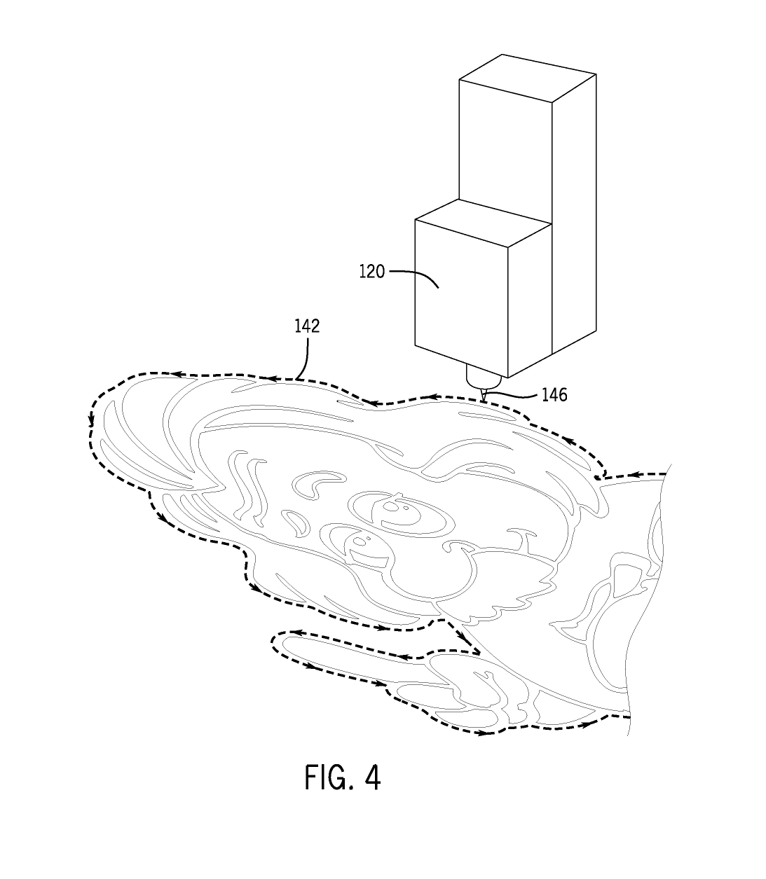

Referring again to FIG. 4 the cutting pattern may be revised by an algorithm based upon the vector offset of each section relative to the graphic image stored in memory. This allows the cutting pattern to more accurately reflect the intention of the designer to cut the image along a predetermined boundary. Since a graphic image may be distorted from an original graphic image stored in memory differently in the various regions, the comparison of multiple sections of the graphic image itself with corresponding multiple regions of the graphic image stored in memory allows for a cutting pattern to be adjusted throughout the predetermined cutting pattern.

Vision system may include a camera interface utility having a communication driver to communicate with the camera for image acquisition and parameterization such as exposure time and local image storing to memory and/or to a hard drive. The communication method from the processor to the camera may be an Ethernet and a separate digital input output connection may be used between the camera and a Baldor Server Drive for high speed triggering. In one embodiment a camera having a grey scale with approximately 800×600 pixel resolution may be used. Of course a camera having a color scale and greater or less resolution than 800×600 pixels may also be used. Grey scale cameras and processing may provide greater speed, while color scale may increase processing time and reduced speed. In one embodiment it the vision system may move at 60″ per second. The camera may have a field of view of 2 inches horizontal and lighting may be provided to enhance the actual images captured. Of course other vision systems having different speeds and field of view are contemplated. It is anticipated that the positioning and distortion may be measured with an accuracy of +/−0.01mm. Though greater positioning and distortion accuracy may is contemplated. Depending on the graphic image to be cut, greater or less accuracy may acceptable and are contemplated.

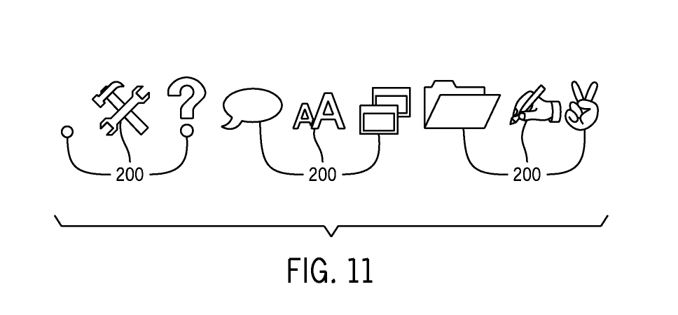

Referring to FIG. 11 in one embodiment at least one mark 200 may be inserted onto the graphic image on sheet 132. In one embodiment the apparatus and process for registration of the sheet based graphic with the master graphic is based on sweeping camera motions and non-predetermined features of the printed graphic. In one embodiment to accommodate all user preferences, existing workflows and unforeseen registration challenges, adding a feature for reading registration marks 200 can be used.

The use of marks 200 minimizes error in registering the wrong master graphic feature with a scanned feature of the printed sheet based graphic. The use of marks 200 will minimize manual location of registration features especially when producing rigid graphics. The initial position, scale, rotation and mirroring are handled automatically based on a single registration mark 200. Registration marks 200 could be read on-the-fly rather than stopping the camera over each mark.

A single asymmetrical mark 200 can be sued to determine the position, scale, rotation and mirroring of the job, while subsequent marks refine the position, oreientation and scale. Note that marks 200 can be used in conjunction with the methods discussed above.

Mark 200 includes features that provide both its location in the x-y plane of table 112 its angular orientation. For example a round dot would provide an x-y location relative to table and/or sheet 132 but would not provide the angular orientation or scale of mark 200 relative to the cutting table 112 or to sheet 132. Mark 200 may be selected from any mark that provides an x-y location, its angular orientation and/or its scale. Referring to FIG. 11 a number of unique marks are provided. In one embodiment marks 200 are inserted into a graphic with known locations relative to the master graphic. In one embodiment a plurality of marks 200 are inserted into a master graphic where each mark is different from the other marks. The marks 200 may be positioned onto the master graphic by a user who purposely places the unique marks in the master graphic in regions that will not intrude on the original graphic of interest. For example if the original graphic includes the face of a person, the mark 200 may be place in a region toward the side of the face such that the placement of the mark does not detract from the original graphic. In one embodiment each mark 200 is about ¼ inch in size. However the size of the mark may be dependent on the technology used to print the graphic and marks. The mark needs to be of sufficient size to provide the location, angular orientation and scale when printed along with the original graphic and be recognized by the vision system 114.

In one embodiment it is contemplated that an algorithm would automatically insert the unique marks onto the original graphic based on a number of rules that would minimize the marks 200 from detracting from the original graphic. In one embodiment the algorithm places the unique marks 200 on regions of the graphic that will be cut away by cutting system 110. In one embodiment the algorithm places the unique marks 200 on regions of the graphic that fall within an area to be saved once the unwanted portion of the graphic is cut away by cutting system 110. In this embodiment, the algorithm will select location within the graphic that will be detectable by vision system 114 and will not detract from the original graphic. For example unique mark 200 will be placed in an area where there is little if any graphic. By way of example areas of dark color on the original graphic may be avoided in favor of areas in which a light color or no color exists.

In one embodiment the mark 200 may include a QR-code (Quick Response Code) that is asymmetrical to ensure that the QR-code provides an x-y location, angular orientation, and scale. The QR-code has the additional benefit of including additional meta-data such as file name, material, thickness, number of copies, due date, customer, delivery date and other customer and/or production related information.

In one embodiment the algorithm places the unique marks 200 on regions of the graphic that will be cut away by cutting system 110. In one embodiment the algorithm places the unique marks 200 on regions of the graphic that fall within an area to be saved once the unwanted portion of the graphic is cut away by cutting system 110. In this embodiment, the algorithm will select location within the graphic that will be detectable by vision system 114 and will not detract from the original graphic. For example unique mark 200 will be placed in an area where there is little if any graphic. By way of example areas of dark color on the original graphic may be avoided in favor of areas in which a light color or no color exists.

In one embodiment the use of marks 200 can be used either in combination with the sections the graphic image as discussed above to positively locate the image relative to the master graphic. Image segments would be captured as discussed above, however where a unique mark 200 is identified within the image segment, the system would have additional positive information as to the location, scale and orientation of the graphic by comparing the scanned unique mark with the precise location of that unique mark in the master graphic.

In one embodiment the unique marks 200 may be the sole basis upon which the image segments are evaluated and compared to the master graphic for determining adjustments to the cutting pattern.

In one embodiment the entire layer of marks 200 are stored in the processor that operates the vision module, which identifies and trains each mark before production begins. The vision module then sends the plotter to the expected position of the first mark. Upon reading the first mark the vision module approximates the position, scale, rotation and mirroring of the job, and then proceeds to locate the remaining marks based on that approximation. The approximation could be refined for each subsequent mark. After reading all of the marks the vision module returns the expected location and actual location of each mark to the processor.

In one embodiment a process for cutting an image comprises providing a sheet based graphic; providing a master graphic; capturing a plurality of non-predetermined portions of the sheet based graphic; registering the plurality of non-predetermined portions of the sheet based graphic with corresponding portions of the master graphic; and identifying an offset of each of the plurality of non-predetermined portions of the sheet based graphic with the corresponding portions of the master graphic.

This process can also include any one of the following either alone or in any combination: scanning a first sheet based graphic with a vision system; setting a cut pattern; determining the orientation of the sheet based graphic on the cutting table based on the offsets; determining the distortion between each of the plurality of portions based upon the offsets; determining a center of gravity of a plurality of points located within each portion;

Registering the potions can also include pattern matching. In one embodiment the non-predetermined portions are non-predetermined geometric shapes that are part of the graphic. In one embodiment at least one of the non-predetermined portions include a unique mark providing location, scale and angular orientation of the mark relative to the sheet based graphic. In one embodiment the mark is QR-code.

The process as noted above can be repeated for a subsequent sheet based graphic wherein the step of capturing a plurality of non-predetermined portions of the sheet based graphic are different than the plurality of non-predetermined portion of the first sheet based graphic.

Additionally, the process as outlined above can include automatically applying a plurality of unique marks different from one another onto the master graphic and printing the unique marks with the printing of the sheet based graphic and comparing the location of the each unique mark identified in each non-predetermined portion to the location of the corresponding unique mark in the master graphic.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein.

What is claimed is:

1. A process for cutting an image comprising:
providing a sheet based graphic;
providing a master graphic;
capturing a plurality of non-predetermined portions of the sheet based graphic;
registering the plurality of non-predetermined portions of the sheet based graphic with corresponding portions of the master graphic; and
identifying an offset of each of the plurality of non-predetermined portions of the sheet based graphic with the corresponding portions of the master graphic.

2. The process of claim 1, further including scanning a first sheet based graphic with a vision system.

3. The process of claim 1, further including setting a cut pattern

4. The process of claim 1, determining the orientation of the sheet based graphic on the cutting table based on the offsets.

5. The process of claim 1, determining the distortion between each of the plurality of portions based upon the offsets.

6. The process of claim 1, determining a center of gravity of a plurality of points located within each portion.

7. The process of claim 1, wherein registering the portions include pattern matching.

8. The process of claim 1, wherein the non-predetermined portions are non-predetermined geometric shapes that are part of the graphic.

9. The process of claim 1, wherein at least one of the non-predetermined portions include a unique mark providing location, scale and angular orientation of the mark relative to the sheet based graphic.

10. The process of claim 9, wherein the mark is a QR-code.

11. The process of claim 1, further providing a subsequent sheet based graphic and repeating steps b-f wherein the step of capturing a plurality of non-predetermined portions of the sheet based graphic are different than the plurality of non-predetermined portion of the first sheet based graphic.

12. The process of claim 1, further including automatically applying a plurality of unique marks different from one another onto the master graphic and printing the unique marks with the printing of the sheet based graphic and comparing the location of the each unique mark identified in each non-predetermined portion to the location of the corresponding unique mark in the master graphic.

13. An apparatus comprising:
a vision system including a camera comprising a processor that includes instructions to:
capture a plurality of non-predetermined portions of a sheet based graphic positioned on a cutting surface as the camera is moved along a predetermined path over the cutting surface;
register the plurality of non-predetermined portions of the sheet based graphic with corresponding portions of a master graphic stored in a memory; and
identify an offset of each of the plurality of non-predetermined portions of the sheet based graphic with the corresponding portions of the master graphic.

14. The apparatus of claim 13, further including
a cutting system that includes a cutting table supporting the cutting surface;
a cutting tool; and
a drive system moving the cutting tool relative to the cutting surface head, a drive about the cutting pattern.

15. The apparatus of claim 13 wherein the processor includes instructions to the drive system to move the camera along a path relative to the sheet based graphic.

16. The apparatus of claim 13 wherein the processor includes instructions to determine the orientation of the sheet based graphic on the cutting table based on the offsets.

17. The apparatus of claim 16, wherein the processor includes instructions to determine distortion between each of the plurality of portions based upon the offsets.

18. The apparatus of claim 17, wherein the non-predetermined portions are non-predetermined geometric shapes that are part of the graphic.

19. The apparatus of claim 18, wherein at least one of the non-predetermined portions include a unique mark providing location, scale and angular orientation

20. The apparatus of claim 13, further including a preprocessor that applies a plurality of unique marks different from one another onto the master graphic and wherein the processor includes instructions to compare the location of the each unique mark identified in each non-predetermined portion to the location of the corresponding unique mark in the master graphic.
